(19) United States
(12) Patent Application Publication
(10) Pub. No.: US 2018/0039873 A1
(43) Pub. Date: Feb. 8, 2018

(54) ACTIVE RADIO FREQUENCY IDENTIFICATION TAG

(71) Applicant: WAYS TECHNICAL CO., LTD., Taoyuan (TW)

(72) Inventor: SHIH-WEN LIAO, Taoyuan (TW)

(21) Appl. No.: 15/258,178

(22) Filed: Sep. 7, 2016

(30) Foreign Application Priority Data
Aug. 4, 2016 (TW) 105211804

(51) Int. Cl. G06K 19/07; G06K 19/077

(52) U.S. Cl. CPC G06K 19/0708; G06K 19/0723; G06K 19/077; G06K 19/0704; H01G 9/20

(57) ABSTRACT

An active RFID tag includes a first substrate, an electrically conductive layer disposed on the first substrate and etched or printed to form an antenna and a circuit, a thin film photovoltaic cell installed on the electrically conductive layer and electrically coupled to the electrically conductive layer, a thin film energy storage device installed on the electrically conductive layer and electrically coupled to the circuit of the electrically conductive layer, and an RFID chip installed on the electrically conductive layer and electrically coupled to the electrically conductive layer.

### FIELD OF THE INVENTION

The present invention relates to an active radio frequency identification (RFID) tag, more particularly to the RFID tag using a thin film photovoltaic cell for power supply and having a thin film energy storage device for storing the electric power, and the RFID tag has green energy and is capable of operating continuously for a long time.

### BACKGROUND OF THE INVENTION

### 1. Description of the Related Art

In recent years, identification devices using a non-contact way to transmit radio signals are commonly used. In these devices, information is exchanged between the device and an external read/write device in order to achieve the information transmission and identification effects. Radio Frequency Identification (RFID) tag is a novel radio transmission device used extensively in the areas such as logistics management, merchandise management, and medical management. Based on the non-contact and easy-to-use characteristics, RFID systems have gradually replaced the conventional contact identification systems such as the barcode scanning systems.

The so-called RFID tag generally includes an RF chip and an antenna coupled to the RF chip. Through the antenna, the RF chip is capable of transmitting radio signals to an external read/write device for accessing data to produce the identification effect.

The RFID tag is mainly divided into an active RFID tag and a passive RFID tag. The active RFID tag uses an external power supply device (such as a battery) to supply electric power to the RFID tag, and the passive RFID tag directly supply the electric power by the radio wave transmitted by the external read/write device, and the active RFID tag capable of continuously providing identification signals are used more extensively.

At present, most countries promote the use of renewable energy, so that some manufacturers use thin film photovoltaic cell as a power source of the active RFID tag, and its architecture is shown in FIG. 1. A thin film photovoltaic cell 1, an electrically conductive layer 2, and an RFID chip 3 are installed on a substrate 4, and then the thin film photovoltaic cell 1, the electrically conductive layer 2, the RFID chip 3, and the substrate 4 are sealed after an upper substrate layer 5 and a lower substrate layer 6 are fixed by an adhesive layer 7. Although the conventional active RFID tag adopting the thin film photovoltaic cell 1 can achieve the power saving effect, yet the thin film photovoltaic cell 1 requires sunlight to convert light into electric power for the power supply. If there is insufficient light source, then the active RFID tag will be unable to operate continuously for a long time. Therefore, it is necessary to develop an active RFID tag capable of saving energy and operating continuously and stably at the same time.

### 2. Summary of the Invention

In view of the drawbacks of the prior art, it is a primary objective of the present invention to provide an active RFID tag that uses a thin film photovoltaic cell to supply power and has a thin film energy storage device to store the power, and the active RFID tag has green energy and operates continuously for a long time.

To achieve the aforementioned and other objectives, the present invention provides an active RFID tag, comprising: a first substrate; an electrically conductive layer, disposed on the first substrate, and etched or printed to form an antenna and a circuit; a thin film photovoltaic cell, installed on the electrically conductive layer and electrically coupled to the circuit of the electrically conductive layer; a thin film energy storage device, installed on the electrically conductive layer and electrically coupled to the circuit of the electrically conductive layer; and an RFID chip, installed on the electrically conductive layer and electrically coupled to the circuit of the electrically conductive layer.

Preferably, the thin film photovoltaic cell, the thin film energy storage device and the RFID chip are installed by bonding or soldering.

Preferably, the active RFID tag further comprises a lower substrate layer and an upper substrate layer, and the lower substrate layer is disposed below the first substrate, and the upper substrate layer is disposed above the thin film photovoltaic cell, the thin film energy storage device and the RFID chip, and an adhesive layer is bonded and formed between the lower substrate layer and the upper substrate layer.

Preferably, the first substrate, the lower substrate layer and the upper substrate layer are made of translucent plastic or translucent glass.

Preferably, the translucent plastic includes but not limited to PET, PE, PMMA, PI, PA, PU or acrylic.

Preferably, the thickness of the first substrate is from 10 um to 500 um.

Preferably, the thickness of the lower substrate layer and the upper substrate layer is from 50 um to 500 um.

Preferably, the thin film photovoltaic cell includes a switching unit electrically coupled to the thin film energy storage device for controlling the thin film photovoltaic cell to transmit the converted electric power to the RFID chip, or controlling the thin film photovoltaic cell to transmit the converted electric power to the thin film energy storage device, and then the thin film energy storage device supplies the electric power to the RFID chip.

Preferably, the thickness of the thin film photovoltaic cell is smaller than 10 um.

Preferably, the thin film photovoltaic cell includes but not limited to an OPV cell or a perovskite solar cell.

Preferably, the thickness of the thin film energy storage device is smaller than 2 mm.

Preferably, the thin film energy storage device is a thin film rechargeable battery or a thin film capacitor.

Preferably, the thin film capacitor is a thin film supercapacitor.

To achieve the aforementioned and other objectives, the present invention further provides an active RFID tag, comprising: a first substrate; a thin film energy storage device, installed on the first substrate; an electrically conductive layer, disposed on the thin film energy storage device, and etched or printed to form an antenna and a circuit, and the circuit of the electrically conductive layer being electrically coupled to the thin film energy storage device; a thin film photovoltaic cell, installed on the electrically conductive layer and electrically coupled to the circuit of the electrically conductive layer; and an RFID chip, installed on the electrically conductive layer and electrically coupled to the circuit of the electrically conductive layer.

Preferably, the active RFID tag further comprises a second substrate disposed between the thin film energy storage device and the electrically conductive layer, and the second substrate has a through hole, and the thin film energy storage device is electrically coupled to the circuit of the electrically conductive layer through the through hole.

Preferably, the active RFID tag further comprises a second substrate, disposed between the thin film energy storage device and the electrically conductive layer, and the second substrate has a printed conductive paste layer formed thereon, and the thin film energy storage device and the circuit of the electrically conductive layer are electrically coupled to each other through the printed conductive paste layer.

### BRIEF DESCRIPTION OF THE DRAWINGS

FIG. 1 is a schematic view of a conventional RFID tag;

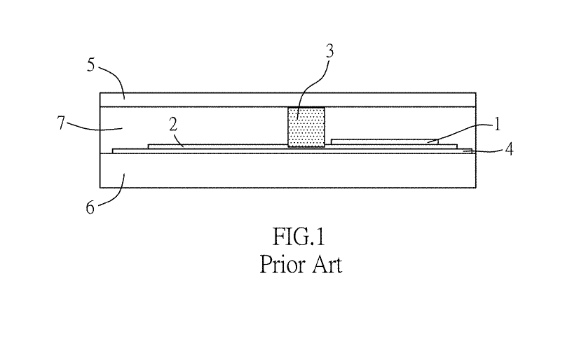

FIG. 2 is a first schematic view of an active RFID tag in accordance with a first preferred embodiment of the present invention;

FIG. 3 is a second schematic view of an active RFID tag in accordance with the first preferred embodiment of the present invention;

FIG. 4 is a schematic view of an active RFID tag in accordance with a second preferred embodiment of the present invention;

FIG. 5 is a first schematic view of an active RFID tag in accordance with a third preferred embodiment of the present invention;

FIG. 6 is a second schematic view of an active RFID tag in accordance with the third preferred embodiment of the present invention;

FIG. 7 is a schematic view of an active RFID tag in accordance with a fourth preferred embodiment of the present invention; and

FIG. 8 is a block diagram of a power supply structure of an active RFIF tag of the present invention.

### DESCRIPTION OF THE PREFERRED EMBODIMENTS

The above and other objects, features and advantages of this disclosure will become apparent from the following detailed description taken with the accompanying drawings. It is noteworthy that the drawings are intended for illustrating the invention and not necessarily drawn according to the actual proportion and precise configuration for the implementation of the present invention and not intended for limiting the scope of the invention.

The active RFID tag of the present invention is thin and can be attached to any device without much environmental limitations. Based on the requirements of green energy and continuous use, the present invention adopts a thin film photovoltaic cell combined with a thin film energy storage device, so that the RFID chip can obtain electric power continuously for a long time, and the operation of the active RFID tag will not be interrupted by insufficient light source.

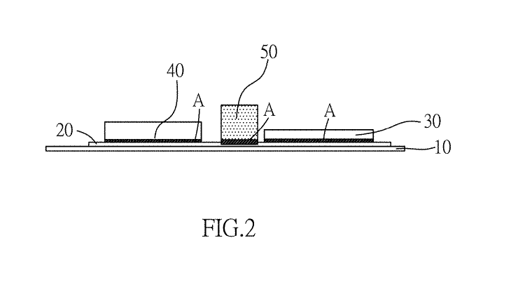

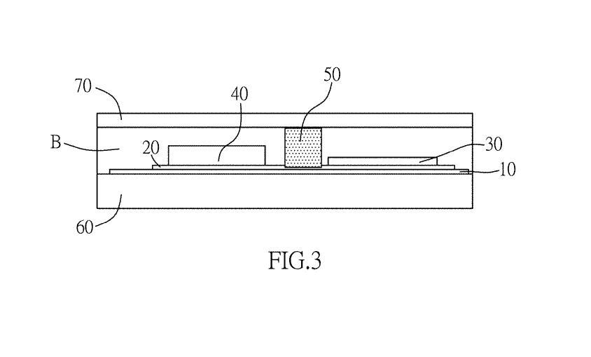

With reference to FIGS. 2 and 3 for the first and second schematic views of an active RFID tag in accordance with the first preferred embodiment of the present invention respectively, the RFID tag of the first preferred embodiment comprises a first substrate 10, an electrically conductive layer 20, a thin film photovoltaic cell 30, a thin film energy storage device 40 and an RFID chip 50. The electrically conductive layer 20 is disposed on the first substrate 10 and etched or printed to form an antenna and a circuit. The thin film photovoltaic cell 30 is installed on the electrically conductive layer 20 and electrically coupled to a circuit of the electrically conductive layer 20. The thin film energy storage device 40 is installed on the electrically conductive layer 20 and electrically coupled to the circuit of the electrically conductive layer 20. The RFID chip 50 is installed on the electrically conductive layer 20 and electrically coupled to the circuit of the electrically conductive layer 20. Wherein, the thin film photovoltaic cell 30, the thin film energy storage device 40, and the RFID chip 50 are installed on the electrically conductive layer 20 by bonding or soldering. If the bonding method is used, the thin film photovoltaic cell 30, the thin film energy storage device 40 and the RFID chip 50 will form an adhesive layer A with the electrically conductive layer 20 separately.

Wherein, the active RFID tag further comprises a lower substrate layer 60 and an upper substrate layer 70. The lower substrate layer 60 is disposed below the first substrate 10, and the upper substrate layer 70 is disposed above the thin film photovoltaic cell 30, the thin film energy storage device 40 and the RFID chip 50, and an adhesive layer B is formed and bonded between the lower substrate layer 60 and the upper substrate layer 70 by sealing. Therefore, the components including the first substrate 10, the electrically conductive layer 20, and the thin film photovoltaic cell 30 are packaged between the lower substrate layer 60 and the upper substrate layer 70.

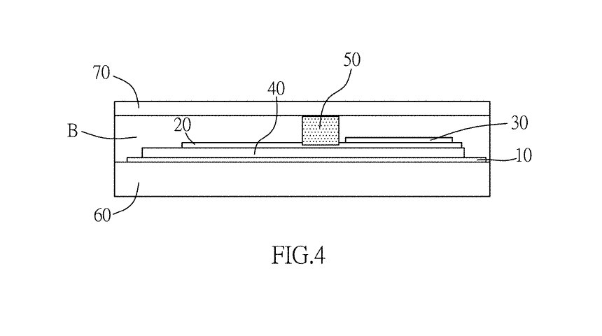

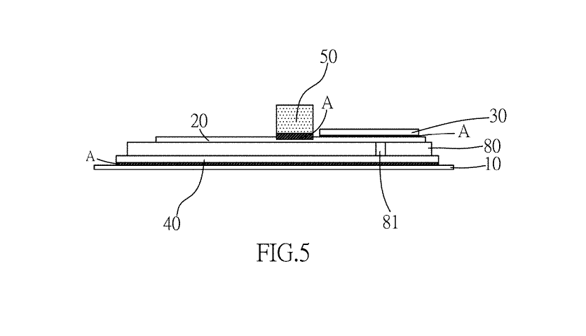

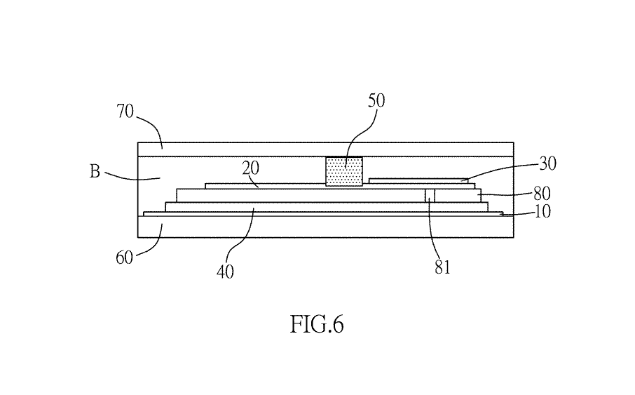

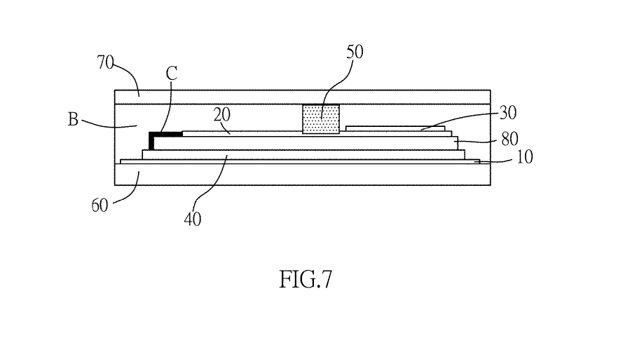

With reference to FIGS. 4 to 7 for the schematic view of an active RFID tag of the second preferred embodiment of the present invention, the first and second schematic views of the third preferred embodiment of the present invention, and the schematic view of an active RFID tag of the fourth preferred embodiment of the present invention respectively, the active RFID tag of the second preferred embodiment of the present invention also comprises a first substrate 10, an electrically conductive layer 20, a thin film photovoltaic cell 30, a thin film energy storage device 40, an RFID chip 50, a lower substrate layer 60 and an upper substrate layer 70, and a slightly different structure resides on that the thin film energy storage device 40 is installed on the first substrate 10, and the electrically conductive layer 20 is disposed on the thin film energy storage device 40, and the circuit of the electrically conductive layer 20 is electrically coupled to the thin film energy storage device 40, and the thin film photovoltaic cell 30 is installed on the electrically conductive layer 20 and electrically coupled to the circuit of the electrically conductive layer 20, and the RFID chip 50 is installed on the electrically conductive layer 20 and electrically coupled to the circuit of the electrically conductive layer 20, and the lower substrate layer 60 and the upper substrate layer 70 may be packaged by an adhesive layer B. In addition, the active RFID tag further comprises a second substrate 80 disposed between the thin film energy storage device 40 and the electrically conductive layer 20, and the second substrate 80 has a through hole 81, and the thin film energy storage device 40 is electrically coupled to the circuit of the electrically conductive layer 20 through the through hole 81 as shown in the figure corresponsive to the third preferred embodiment; or the active RFID tag comprises a second substrate 80 disposed between the thin film energy storage device 40 and the electrically conductive layer 20, and the second substrate 80 has a printed conductive paste layer C formed thereon, and the thin film energy storage device 40 and the circuit of the electrically conductive layer 20 are electrically coupled through the printed conductive paste layer C as shown in the figure corresponsive to the fourth preferred embodiment. Wherein, the thin film photovoltaic cell 30, the thin film energy storage device 40 and the RFID chip 50 are installed through an adhesive layer A or installed by soldering. In the second to fourth preferred embodiments of the present invention, the architecture of the active RFID tag may adopt a thin film energy storage device 40 with a larger volume to obtain larger electric power storage.

In each of the foregoing preferred embodiments, the first substrate 10, the second substrate 80, the lower substrate layer 60 and the upper substrate layer 70 are made of translucent plastic or translucent glass, and the thickness of the first substrate 10 and the second substrate 80 is preferably from 10 um to 500 um, and the thickness of the lower substrate layer 60 and the upper substrate layer 70 is preferably from 50 um to 500 um, wherein the translucent plastic includes but not limited to PET, PE, PMMA, PI, PA, PU or acrylic.

In each of the foregoing preferred embodiments, the thin film photovoltaic cell 30 is an OPV cell or a perovskite solar cell, and the thickness of the thin film photovoltaic cell 30 is preferably smaller than 10 um.

In each of the foregoing preferred embodiments, the thin film energy storage device 40 is a thin film rechargeable battery or a thin film capacitor, and the thickness of the thin film energy storage device 40 is smaller than 2 mm, wherein the thin film capacitor is a thin film supercapacitor.

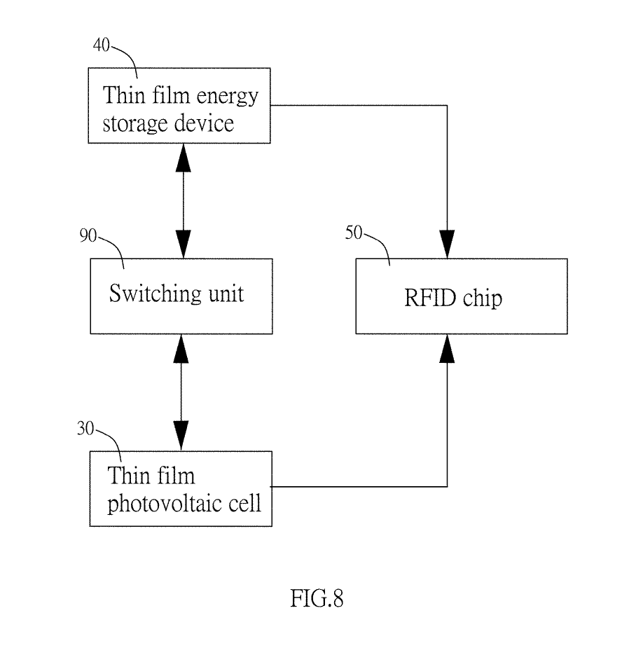

In each of the foregoing preferred embodiments, the thin film photovoltaic cell 30 includes a switching unit 90 electrically coupled to thin film energy storage device 40. The switching unit 90 is provided for controlling the thin film photovoltaic cell 30 to transmit the converted electric power to the RFID chip 50 directly, or the switching unit 90 is provided for controlling the thin film photovoltaic cell 30 to transmit the converted electric power to the thin film energy storage device 40, and then the thin film energy storage device 40 supplies the electric power to the RFID chip 50 as shown in FIG. 8.

In summation of the description above, the active RFID tag of the present invention uses a thin film photovoltaic cell for supplying the electric power generated by photoelectric convention and integrates a thin film energy storage device such as a thin film capacitor for the temporary storage and supply of the electric power, so that electric power can be supplied to the RFID chip of the active RFID tag continuously without being limited by the light source. In addition, the integrated design of the thin film components of the present invention features a flat and simple active RFID tag, and the related components including the thin film energy storage device and the photovoltaic cell can be manufactured by the roll to roll (R2R) process for a low-cost mass production.

In summation of the description above, the present invention breaks through the prior art and achieves the expected and improved effect, and further complies with the patent application requirements, and thus is duly filed for patent application.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An active RFID tag, comprising:
a first substrate;
an electrically conductive layer, disposed on the first substrate, and etched or printed to form an antenna and a circuit;
a thin film photovoltaic cell, installed on the electrically conductive layer and electrically coupled to the circuit of the electrically conductive layer;
a thin film energy storage device, installed on the electrically conductive layer and electrically coupled to the circuit of the electrically conductive layer; and
an RFID chip, installed on the electrically conductive layer and electrically coupled to the circuit of the electrically conductive layer.

2. The active RFID tag of claim 1, wherein the thin film photovoltaic cell, the thin film energy storage device and the RFID chip are installed by bonding or soldering.

3. The active RFID tag of claim 1, further comprising a lower substrate layer and an upper substrate layer, and the lower substrate layer being disposed below the first substrate, and the upper substrate layer being disposed above the thin film photovoltaic cell, the thin film energy storage device and the RFID chip, and an adhesive layer being bonded and formed between the lower substrate layer and the upper substrate layer.

4. The active RFID tag of claim 3, wherein the first substrate, the lower substrate layer and the upper substrate layer are made of translucent plastic or translucent glass.

5. The active RFID tag of claim 4, wherein the translucent plastic is one selected from the group consisting of PET, PE, PMMA, PI, PA, PU and acrylic.

6. The active RFID tag of claim 4, wherein the first substrate has a thickness from 10 um to 500 um.

7. The active RFID tag of claim 4, wherein the lower substrate layer and the upper substrate layer have a thickness from 50 um to 500 um.

8. The active RFID tag of claim 1, wherein the thin film photovoltaic cell includes a switching unit electrically coupled to the thin film energy storage device, for controlling the thin film photovoltaic cell to transmit the generated electric power to the RFID chip, or the switching unit controlling the thin film photovoltaic cell to transmit the converted and generated electric power to the thin film energy storage device, and then the thin film energy storage device supplying the electric power to the RFID chip.

9. The active RFID tag of claim 1, wherein the thin film photovoltaic cell has a thickness smaller than 10 um.

10. The active RFID tag of claim 1, wherein the thin film photovoltaic cell is an organic photovoltaic (OPV) cell or a perovskite solar cell.

11. The active RFID tag of claim 1, wherein the thin film energy storage device has a thickness smaller than 2 mm.

12. The active RFID tag of claim 1, wherein the thin film energy storage device is a thin film rechargeable battery or a thin film capacitor.

13. The active RFID tag of claim 12, wherein thin film capacitor is a thin film supercapacitor.

14. An active RFID tag, comprising:
a first substrate;
a thin film energy storage device, installed on the first substrate;
an electrically conductive layer, disposed on the thin film energy storage device, and etched or printed to form an antenna and a circuit, and the circuit of the electrically conductive layer being electrically coupled to the thin film energy storage device;
a thin film photovoltaic cell, installed on the electrically conductive layer and electrically coupled to the circuit of the electrically conductive layer; and
an RFID chip, installed on the electrically conductive layer and electrically coupled to the circuit of the electrically conductive layer.

15. The active RFID tag of claim 14, further comprising a second substrate disposed between the thin film energy storage device and the electrically conductive layer, and the second substrate having a through hole, and the thin film energy storage device being electrically coupled to the circuit of the electrically conductive layer through the through hole.

16. The active RFID tag of claim 14, further comprising a second substrate installed between the thin film energy storage device and the electrically conductive layer, and the second substrate having a printed conductive paste layer formed thereon, and the thin film energy storage device and the circuit of the electrically conductive layer being electrically coupled to each other through the printed conductive paste layer.

17. The active RFID tag of claim 14, wherein the thin film photovoltaic cell, the thin film energy storage device and the RFID chip are installed by bonding or soldering.

18. The active RFID tag of claim 14, further comprising a lower substrate layer and an upper substrate layer, and the lower substrate layer being disposed below the first substrate, and the upper substrate layer being disposed above the thin film photovoltaic cell, the thin film energy storage device and the RFID chip, and an adhesive layer being attached and formed between the lower substrate layer and the upper substrate layer.

19. The active RFID tag of claim 15, wherein the first substrate, the second substrate, the lower substrate layer and the upper substrate layer are made of translucent plastic or translucent glass.

20. The active RFID tag of claim 19, wherein the translucent plastic is one selected from the group consisting of PET, PE, PMMA, PI, PA, PU and acrylic.

21. The active RFID tag of claim 19, wherein the first substrate and the second substrate have a thickness from 10 um to 500 um.

22. The active RFID tag of claim 19, wherein the lower substrate layer and the upper substrate layer have a thickness from 50 um to 500 um.

23. The active RFID tag of claim 14, wherein the thin film photovoltaic cell includes a switching unit electrically coupled to the thin film energy storage device and provided for controlling the thin film photovoltaic cell to transmit the converted electric power to the RFID chip, or controlling the thin film photovoltaic cell to transmit the converted electric power to the thin film energy storage device, and then the thin film energy storage device supplies the electric power to the RFID chip.

24. The active RFID tag of claim 14, wherein the thin film photovoltaic cell has a thickness smaller than 10 um.

25. The active RFID tag of claim 14, wherein the thin film photovoltaic cell is an OPV cell or a perovskite solar cell.

26. The active RFID tag of claim 14, wherein the thin film energy storage device has a thickness smaller than 2 mm.

27. The active RFID tag of claim 14, wherein the thin film energy storage device is a thin film rechargeable battery or a thin film capacitor.

28. The active RFID tag of claim 27, wherein the thin film capacitor is a thin film supercapacitor.
